(19) United States
(12) Patent Application Publication
(10) Pub. No.: US 2021/0186816 A1
(43) Pub. Date: Jun. 24, 2021

(54) APPARATUS AND METHOD FOR THE AUTOMATED PRODUCTION OF CUSTOMIZABLE DOSAGE FORMS

(71) Applicant: ULIA PHARMA SRL, Vemole (Lecce) (IT)

(72) Inventor: Carlo DE GIORGI, Milano (IT)

(21) Appl. No.: 17/045,601

(22) PCT Filed: Apr. 3, 2019
(86) PCT No.: PCT/EP2019/058415

§ 371 Date: Oct. 6, 2020

(30) Foreign Application Priority Data
Apr. 6, 2018 (IT) 102018000004265

(51) Int. Cl. A61J 3/00; A61J 3/06; B33Y 10/00; B33Y 30/00; B33Y 80/00

(52) U.S. Cl. CPC A61J 3/005; A61J 3/06; B33Y 80/00; B33Y 30/00; B33Y 10/00

(57) ABSTRACT

An apparatus for the automated production of customizable dosage forms, the apparatus including a sterile chamber inside which a dosage form is formed. The apparatus further includes:
a core supporting assembly for retaining a core inside the sterile chamber,
one or more dispensing devices, each of which is configured to emit, in a controlled manner, in the direction of the core, a jet of a pharmaceutical compound,
The apparatus further includes a motor assembly adapted to transmit a rotation about a central rotation axis to the core supporting assembly and with it to the core or to at least one dispensing device.

### TECHNICAL FIELD

The present disclosure relates to an apparatus and a method for the automated production of customizable pharmaceutical dosage forms which are useful and practical particularly in the pharmaceutical field. In greater detail, the disclosure relates particularly, but not exclusively, to the production of dosage forms (or pharmaceutical forms) for oral administration, such as for example pills or tablets, in the hospital sector.

As medical science progresses, the creation of customized medicines based on the needs of the individual patient is required increasingly. In fact, therapies are often performed which require taking drugs whose characteristics, such as composition and release kinetics, must vary from patient to patient as well as, optionally, according to the evolution of the clinical condition.

In order to perform such customized therapies, it is thus useful to have available, in the hospital sector, methods for producing customized medicinal preparations in an automated, precise, safe and controlled manner

### BACKGROUND

Currently, the methods for the preparation and administration of customized medicinal preparations entail the use of machines that mix the components, obtaining a liquid mixture that is administered intravenously. These machines of a known type normally comprise syringes and bottles handled by robotic arms.

These machines of the known type, although reliable and effective, are bulky and expensive.

Furthermore, the limitations and drawbacks of intravenous administration are known and in some cases it would be preferable to have different dosage forms available.

In particular, in some cases it would be more convenient and practical for the patient to have the customized drug available in a dosage form suitable for oral administration, such as for example in the form of pills or tablets.

Normally, the production of customized pills and tablets is performed with very laborious methods, which are not adapted to be performed in an automated manner in the hospital sector.

For example, WO2017/010938 discloses a method for the production of a customizable dosage form which includes producing a first mold having a variable shape, according to the characteristics that one wishes to obtain, filling said first mold with a solution containing a polymer and at least one active ingredient, polymerizing the solution, obtaining a solid form, introducing the solid form thus obtained in a second mold that is subsequently filled with a second solution containing a second polymer, and finally polymerizing this second solution so as to obtain a solid dosage form.

According to this method, customization occurs by varying the shape of the molds as well as the composition of the solutions.

This known method, although capable of providing a good final product, is very time-consuming and complicated and requires laborious manual intervention by an operator.

Moreover, this known method is not suitable for being performed in a completely automated manner by an apparatus.

Over time, apparatuses for the automated production of customizable dosage forms, and more precisely oral dosage forms, have also been devised which use 3D printing technology and particularly the technology known as “Fused Filament Fabrication” (FFF).

These apparatuses provide for the presence of a plurality of printing stations, each one of which deposits a different component by means of a dispensing device. These printing stations are arranged in line and a conveyance surface, such as for example a conveyor belt, transports the pills being formed from one printing station to the other.

An example of this type of apparatus is described in EP1773708B1 and comprises a conveyor belt that conveys the dosage forms being produced through a series of processing stations arranged in line.

The presence of multiple stations in series makes these apparatuses of a known type particularly bulky and scarcely flexible, since to produce dosage forms with different compositions it is necessary to modify the printing stations.

Moreover, in practice, the risk of cross-contamination is considerable, since residues of a substance used for the production of a previous dosage form may remain on the conveyance surface and may contaminate a dosage form produced subsequently.

Other methods known in the art use apparatuses in which the work surface is fixed and the dispensing devices move with respect to the surface.

For example, U.S. Pat. No. 7,276,252B2 discloses a method for the production of oral dosage forms provided by virtue of a three-dimensional printing apparatus (or 3D printing).

In greater detail, U.S. Pat. No. 7,276,252B2 discloses an apparatus that comprises a 3D printer comprising a horizontal resting surface on which the dosage form is formed and one or more dispensing devices that can translate along two perpendicular axes and are positioned above the horizontal surface so as to dispense, from above, appropriate quantities of components in liquid form.

The process disclosed by U.S. Pat. No. 7,276,252B2 provides for depositing on the resting surface a first layer in powder form and then depositing, by means of the dispensing devices, one ore more layers of pharmaceutical components in liquid form. The process can provide for the deposition of multiple alternated layers of powder and liquid until the desired shape and composition are achieved.

This method, although very ingenious, is not free from drawbacks.

In particular, the risk of cross-contamination is particularly high, since the deposition of layers of powder and liquid on a same working surface greatly increases the risk that residues might contaminate a dosage form produced subsequently.

Moreover, if cross-contamination has occurred, a sterilization cycle of the apparatus becomes necessary, with a consequent increase of production times and costs.

Another drawback which is common to all methods and apparatuses of the known type for the production of customizable dosage forms is constituted by the fact that they do not allow effective control in real time of the dosage and compactness of each dosage form being produced. In fact, only spot-checking after the production step is possible in the background art.

Another drawback which is common to all the methods and apparatuses for the production of customizable dosage forms of the known type is constituted by the fact that in order to protect the dosage form from abrasions and mechanical impacts, a step of application of a protective coating is necessary which makes the production process longer, more complicated and expensive.

### SUMMARY

The aim of the present disclosure is to overcome the limitations of the background art described above, devising a method and an apparatus that allow to produce oral dosage forms in the hospital sector in a manner that is automated and at the same time economical, fast and reliable.

Within this aim, an object of the present disclosure is to provide a method and an apparatus that allow to provide oral dosage forms that are completely customizable both in terms of active ingredient and in terms of release rate.

Another object of the disclosure is to provide a method and an apparatus for the automated production of customizable dosage forms that allow to control the dosage and the compactness of each individual dosage form during production.

Another object of the disclosure is to provide a method and an apparatus for the automated production of customizable dosage forms that reduce the risk of cross-contamination with respect to the background art.

Another object of the disclosure is to provide an apparatus for the automated production of customizable dosage forms that is less bulky than the background art.

Another object of the disclosure is to provide an apparatus for the automated production of customizable dosage forms that is more flexible and easier to reconfigure with respect to the background art.

Another object of the disclosure is to provide an apparatus for the automated production of customizable dosage forms that can be returned to work in a faster and more economical manner than the background art if cross-contamination has occurred.

A further object of the disclosure is to provide a method and an apparatus for the automated production of customizable dosage forms that allow to avoid the application of a protective coating without compromising the reliability of the dosage form.

Another object of the disclosure is to provide a method and an apparatus for the automated production of customizable dosage forms that are easy to provide and economically competitive if compared with the background art.

This aim and these and other objects which will become better apparent hereinafter are achieved by an apparatus for the automated production of customizable dosage forms, comprising a sterile chamber inside which a dosage form is formed, characterized in that it comprises:
a core supporting assembly for retaining a core inside said sterile chamber,
one or more dispensing devices, each of which is configured to emit, in a controlled manner, in the direction of the core retained by said core supporting assembly, a jet of a pharmaceutical compound,
a motor assembly, adapted to transmit a rotation about a central rotation axis to said core supporting assembly and with it to said core or to said at least one dispensing device;

said motor assembly and said one or more dispensing devices being configured so that during said rotation said one or more dispensing devices deposit one or more layers of a predefined thickness of said one or more pharmaceutical compounds on a perimetric portion of said core.

This aim and these and other objects are also achieved by a core according to the claims.

This aim and these and other objects are also achieved by a method according to the claims.

### BRIEF DESCRIPTION OF THE DRAWINGS

Further characteristics and advantages will become better apparent from the description of two preferred but not exclusive embodiments of an apparatus for the automated production of customizable dosage forms, illustrated by way of non-limiting example with the aid of the accompanying drawings, wherein:

FIG. 1 is a perspective view of part of a first embodiment of an apparatus according to the disclosure;

FIG. 2 is a lateral elevation view of the apparatus part of FIG. 1;

FIG. 3 is a lateral elevation view of the apparatus part of FIG. 1 from another view point;

FIG. 4 is a top plan view of the apparatus part of FIG. 1;

FIG. 5 is a lateral sectional view of the apparatus part of FIG. 1;

FIG. 6 is a perspective view of a part of a second embodiment of an apparatus, according to the disclosure;

FIG. 7 is a lateral elevation view of the apparatus part of FIG. 6;

FIG. 8 is a lateral elevation view of the apparatus part of FIG. 6 from another viewpoint;

FIG. 9 is a top plan view of the apparatus part of FIG. 6;

FIG. 10 is a lateral sectional view of the apparatus part of FIG. 6;

FIGS. 11 and 12 are, respectively, a perspective view and a lateral sectional view of a first embodiment of a core for the production of a dosage form with an apparatus according to the disclosure;

FIGS. 13 and 14 are, respectively, a perspective view and a lateral sectional view of a second embodiment of a core for the production of a dosage form with an apparatus according to the disclosure;

FIGS. 15 and 16 are, respectively, a perspective view and a lateral sectional view of a third embodiment of a core for the production of a dosage form with an apparatus according to the disclosure;

FIGS. 17 and 18 are, respectively, a perspective view and a lateral sectional view of a fourth embodiment of a core for the production of a dosage form in an apparatus according to the disclosure;

FIG. 19 is a perspective view of part of a further embodiment of an apparatus according to the disclosure; and

FIG. 20 is a lateral elevation view of the apparatus part of FIG. 19.

### DETAILED DESCRIPTION OF THE DRAWINGS

Before delving into the detailed description, it should be noted that the accompanying figures show parts of an apparatus according to the disclosure that is, for the sake of clarity, lacking some parts (e.g., the structural elements that support the dispensing devices), because said parts, besides being known by the person skilled in the art, are not useful for the understanding of the disclosure and would only contribute to an overall cluttering of the figures.

With reference to the above cited figures, the apparatus for the automated production of customizable dosage forms, generally designated by the reference numeral 10, 100 or 1000 depending on the embodiment, comprises a sterile chamber 20 inside which a dosage form is formed.

The sterile chamber 20 is provided with one of the techniques well known in the field and can be of any shape according to the specific requirements.

In the preferred and illustrated embodiments, the sterile chamber 20 comprises a protective shell 21, which is preferably cylindrical and defines inside it a (preferably cylindrical) cavity inside which the dosage forms is formed, as will become better apparent hereinafter.

Preferably, the sterile chamber 20 comprises a temperature, humidity and pressure control system in order to maintain at predetermined values temperature, humidity and pressure within the sterile chamber 20 and, optionally, also a device for creating a laminar flow of sterile air inside said sterile chamber 20.

According to the disclosure, the apparatus 10, 100, 1000 comprises a core supporting assembly 30 for retaining a core 9 inside the sterile chamber 20.

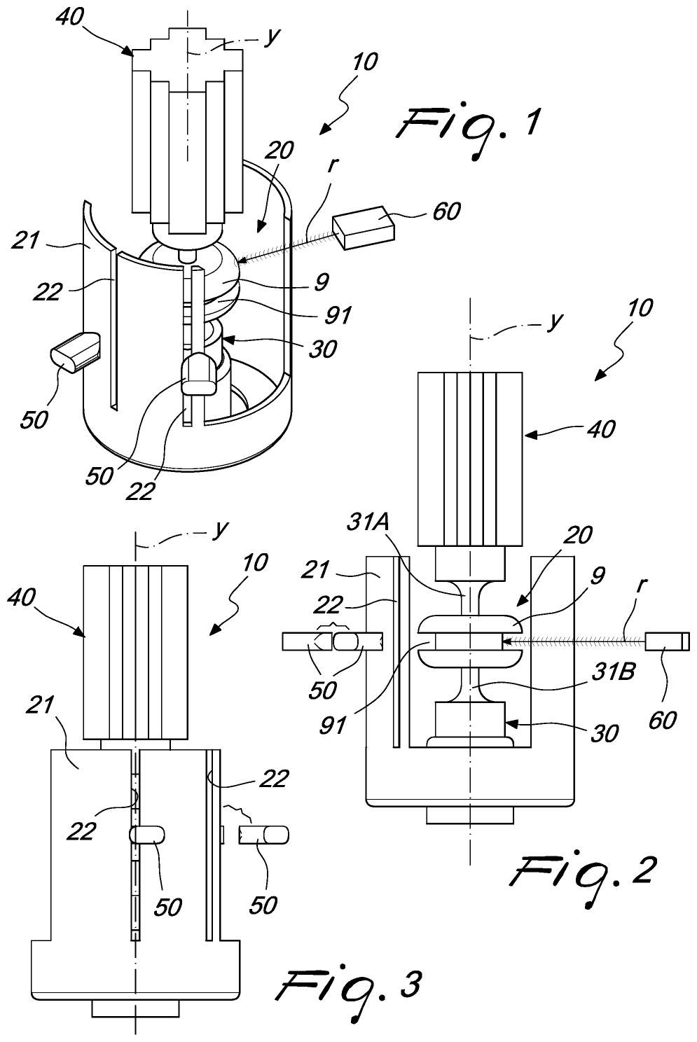

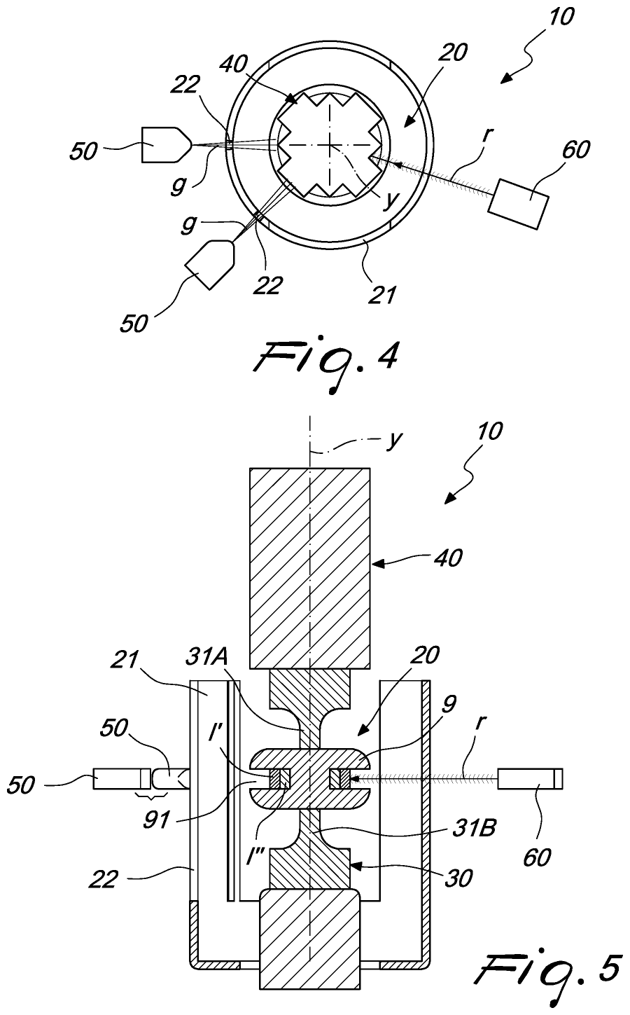

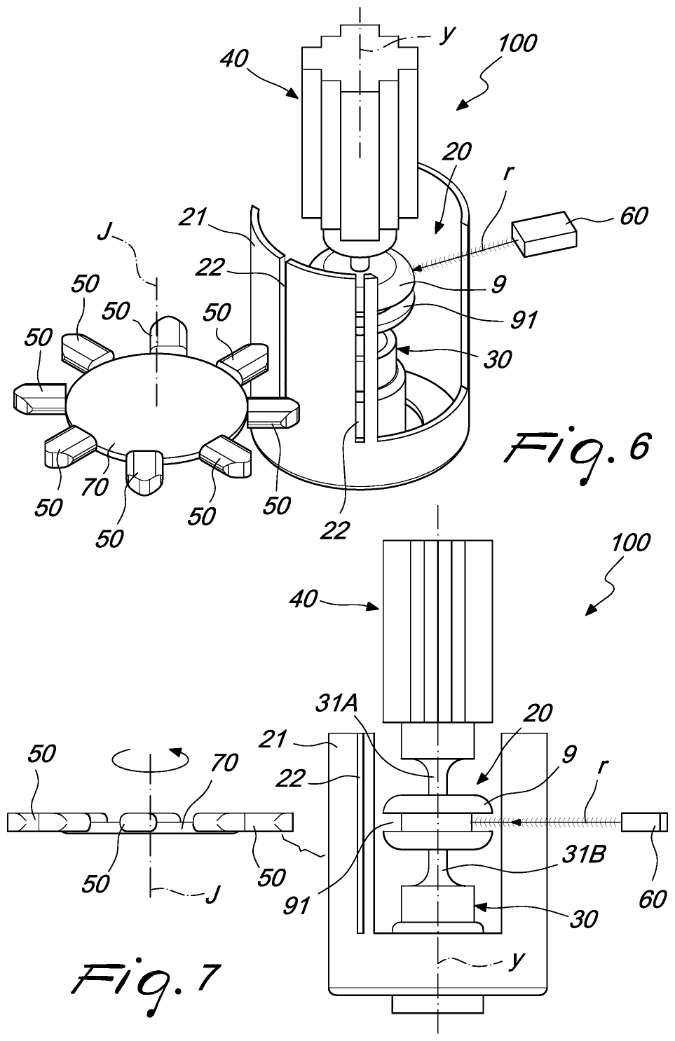

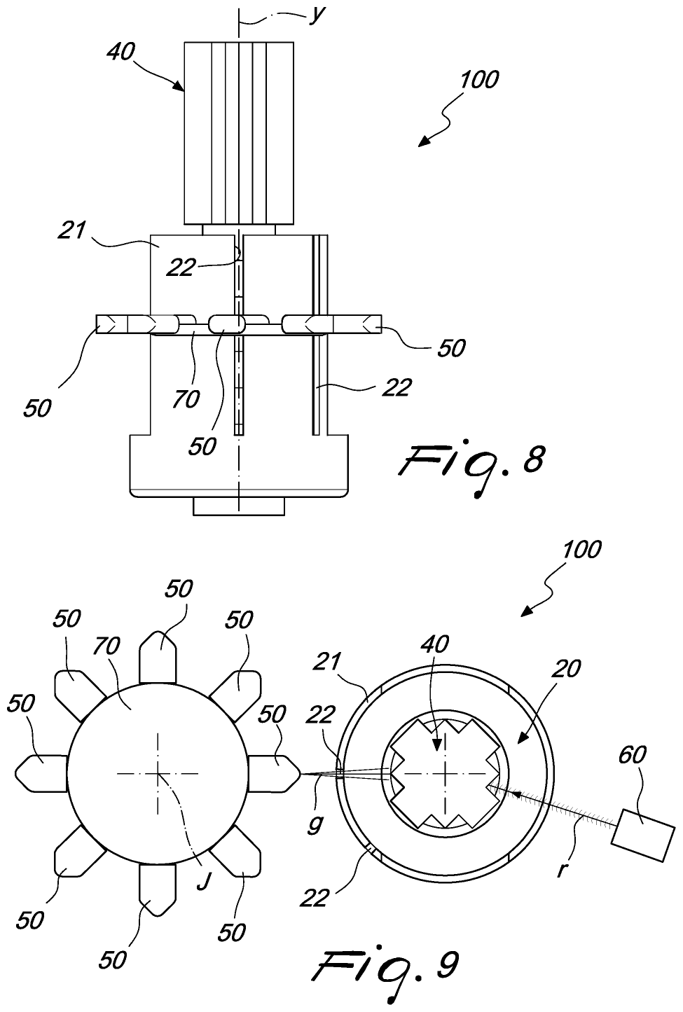

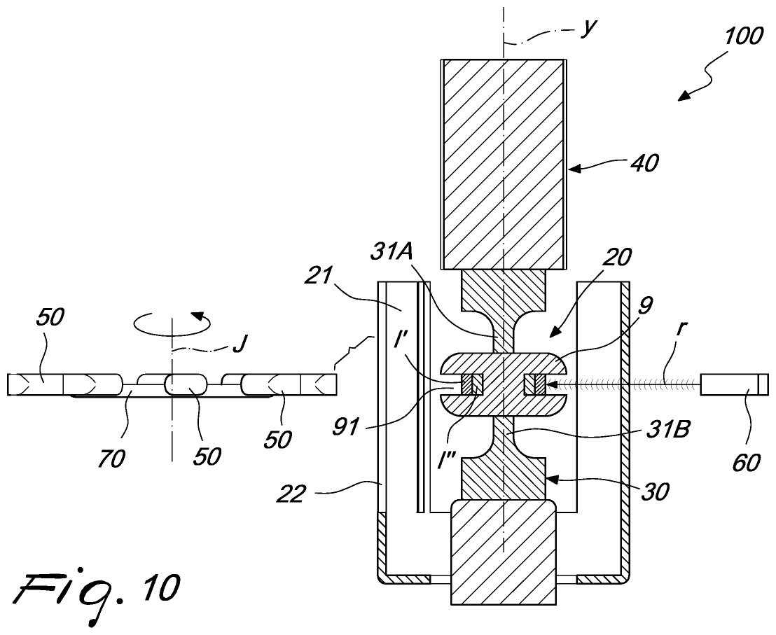

Preferably, as shown in FIGS. 1-10, the core supporting assembly 30 is configured so as to retain the core 9 in a position in which the core 9 is substantially centered on a central rotation axis Y (i.e., with the center of gravity on the central rotational axis Y and preferably, if the core 9 has an axis of symmetry, with the axis of symmetry of the core 9 that coincides with the central rotation axis Y).

The core 9 (or kernel or nucleus) is a supporting structure, made of inert edible material, on which one or more pharmaceutical compounds are applied in order to provide the dosage form; some possible embodiments of a core 9, designated specifically by the numerals 9A, 9B, 9C, 9D, are shown in FIGS. 11 to 18 and will be described in greater detail hereinafter.

It is useful to specify that the expression “pharmaceutical compound” is understood here to be any compound or substance, comprising one or more active ingredients and/or excipients and/or nutraceutical components, suitable for being a component of a dosage form, in any form or state of aggregation.

Going back to the illustrated examples, the core supporting assembly 30 comprises two vertical coaxial stems 31A, 31B adapted to compress between them, in a controlled manner, a core 9 so as to lock it mechanically.

In other possible embodiments, not shown, the core supporting assembly 30 comprises other kinds of means for the mechanical locking of the core, such as for example clamps, jaws, etcetera.

According to the disclosure, the apparatus 10, 100, 1000 comprises moreover one or more dispensing devices 50, each of which is configured to emit, in a controlled manner, in the direction of the core 9 retained by the core supporting assembly 30 (i.e., in the illustrated examples, in the direction of the central rotation axis Y), a jet g of a pharmaceutical compound (preferably in liquid or powder form).

The dispensing devices 50 are, in other words, devices that can be controlled electronically and are capable of generating, in the direction of the core 9, a flow g having a controlled duration and intensity and comprise, for example, nozzles which are oriented (or can be oriented) toward the central rotation axis Y.

The dispensing devices 50 comprise microvalves or other known systems for precision dispensing control and in any case are configured to deposit layers of pharmaceutical compounds on the core with appropriate dosage precision.

Depending on the embodiment, and particularly depending on the type of dispensing device 50 used, each layer can optionally comprise, in turn, one or more filaments, drops, agglomerations or the like.

In greater detail, the dispensing devices 50 can, for example, comprise one or more of the following known systems for controlled dispensing:
inkjet system;
spray systems (such as for example the system known as “sugar coating” or the “film coating” system);
so-called “hot melt coating”;
melted filament system (i.e., the system normally used in 3D printers);
system for coating by using magnetic fields (“electrostatic coating”).

The dispensing devices 50 comprise, or are connected to, at least one tank adapted to contain the pharmaceutical compound to be dispensed.

According to the disclosure, the apparatus 10, 100, 1000 comprises moreover a motor assembly 40 adapted to transmit a rotation, about the central rotation axis Y, to the core supporting assembly 30 and with it to the core 9 or to the dispensing devices 50 at least during the dispensing of the jet g.

According to the disclosure, this rotation can be continuous or intermittent (or stepwise): in some embodiments the dispensing devices 50 dispense the jets g during a continuous rotation (of the core 9 or of the dispensing devices 50), in others the core 9 (or the dispensing devices 50) are rotated by one step (by a certain number of degrees) at a time and after each step an appropriate jet g is dispensed.

In practice, in the preferred and illustrated embodiments the motor assembly 40 rotationally actuates the core supporting assembly 30, which, in turn, rotationally actuates the core 9 about the central axis Y.

In other embodiments, not shown, the motor assembly 40 rotationally actuates the dispensing devices 50, making them rotate about the central axis Y, while the core supporting assembly 30 keeps the core 9 stationary.

By virtue of these characteristics, in all of the embodiments, by actuating the rotation of the core supporting assembly 30 or of the dispensing devices 50, during dispensing, by means of said dispensing devices 50 it is possible to deposit one or more layers 1′, 1″ of pharmaceutical compounds around the core 9.

In fact, according to the disclosure, the motor assembly 40 and the dispensing devices 50 are configured so that during rotation said dispensing devices 50 deposit one or more layers 1′, 1″ of pharmaceutical compounds, each one of a predefined thickness, on at least one perimetric portion of the core 9.

More precisely, in the preferred embodiments, the layers 1′, 1″ are deposited inside a perimetric groove 91 that is present on the core 9.

The motor assembly 40 comprises at least one actuator, such as for example an electric motor, and a kinematic transmission system, comprising for example one or more shafts and/or belts and/or gears, for the transmission of the motion of the actuator to the core supporting assembly 30 or to the dispensing devices 50.

The motor assembly 40 and the dispensing devices 50 are controlled and coordinated automatically according to one of the known techniques, for example by means of a programmable electronic control system (not shown).

As already mentioned, in both of the illustrated embodiments 10, 100 the sterile chamber 20 comprises a substantially cylindrical protective shell 21. It should be noted that said protective shell 21 is interposed between the core supporting assembly 30 and the dispensing devices 50.

Advantageously, the protective shell 21 is provided with one or more slots 22, which in the illustrated example have a longitudinal extension, for the passage of the jets g of pharmaceutical compounds dispensed by the dispensing devices 50 toward the core 9.

FIGS. 1 to 5 show a first embodiment of the apparatus 10, in which the dispensing devices 50 are positioned in a radial pattern around the central rotation axis Y.

It is useful to clarify that the expression “positioned in a radial pattern around the central rotation axis Y” is understood to mean arranged with the dispensing axis (the axis that represents the dispensing direction) oriented like the radius of a circumference centered on the central rotation axis Y.

In the illustrated example, the dispensing devices are arranged along a circumference the center of which is the central rotation axis Y, all at the same distance from said central axis Y; however, the dispensing devices 50 can be equivalently arranged again in a radial pattern, but offset, at different distances from the central axis Y.

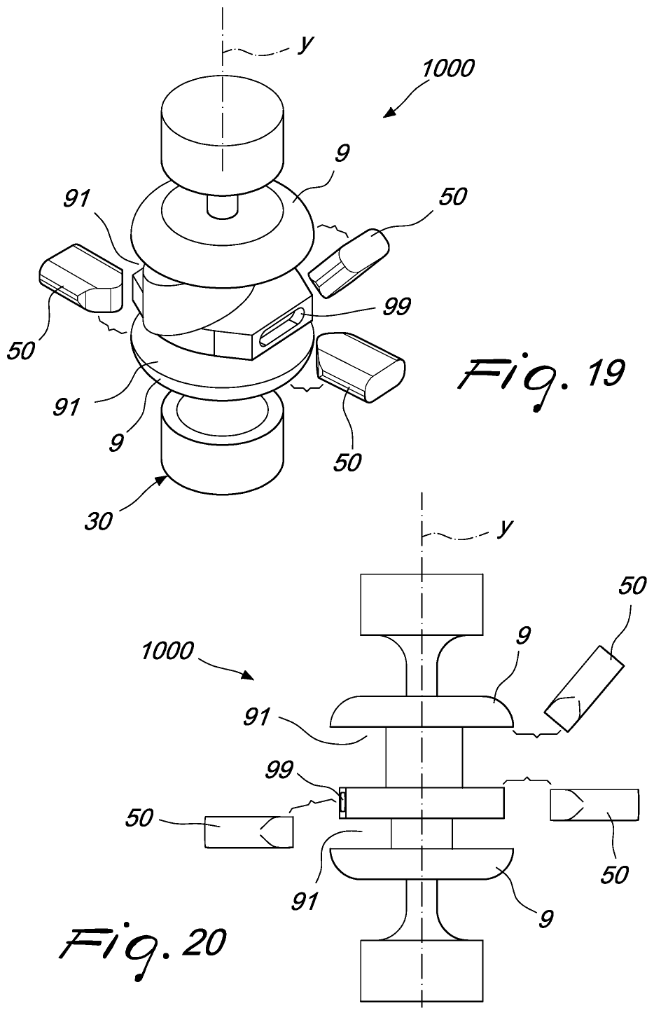

In other embodiments, such as for example in the advanced embodiment 1000 shown partially (only the core supporting assembly 30 and the dispensing devices 50) in FIGS. 19 and 20, at least one of the dispensing devices 50 is arranged along an axis that is inclined (i.e., not perpendicular) with respect to the central rotation axis Y, always oriented toward the latter (i.e., toward the core 9).

Going back to FIGS. 1-5, in this first embodiment the protective shell 21 is provided with a number of longitudinal slots 22 equal to the number of dispensing devices 50. In this manner, the dispensing devices can be activated one by one, in sequence, or more than one simultaneously.

In a possible variation of this first embodiment, the shell 21 is provided with a single longitudinal slot 22 and is rotatable about the central rotation axis Y, so that the slot 22 can be positioned selectively at each dispensing device 50.

FIGS. 6 to 10 show a second embodiment of the apparatus 100, in which multiple dispensing devices 50 are positioned perimetrically on a rotating base 70.

The rotating base 70 can rotate about a peripheral axis J, which in the example shown is substantially parallel to the central rotation axis Y, so that by rotating the base 70 each one of the dispensing devices 50 can be oriented selectively toward the central rotation axis Y.

In the example shown, the base 70 has a circular shape and the dispensing devices 50 are positioned along the circumference of said base 70; in other embodiments, the base 70 has other shapes, such as for example a polygonal shape.

As is clear, in this embodiment only one dispensing device 50 at a time is oriented toward the core 9 and therefore only one dispensing device 50 at a time is activated during operation.

In this manner, the danger of cross-contamination is reduced considerably.

Going back to the characteristics that are common to all of the embodiments, the apparatus 10, 100, 1000 preferably also comprises one or more optical measurement devices 60 for measuring the thickness of the layers 1′, 1″ of pharmaceutical compounds deposited on the core 9 and/or for measuring other physical characteristics of said layers 1′, 1″ (such as for example surface roughness, compactness, color, uniformity, etcetera).

The expression “optical measurement devices” 60 is understood to mean, in a fully general way, any measurement or detection device that by emitting and/or absorbing electromagnetic radiation (light, laser radiation, or any portion of the electromagnetic spectrum) is capable of detecting directly or indirectly the thickness of a deposited layer 1′, 1″ or another physical characteristic (for example by measuring the dimensional variation of the core 9 or by acquiring images of the surface of the layer 1′, 1″). Examples of optical measurement devices 60 present in possible embodiments of the apparatus 10, 100, 1000 are: optical profilometers, interferometers, scanners, video cameras.

In particular, the optical measurement devices 60 present in the preferred and illustrated embodiments comprise at least one laser profilometer positioned in a radial pattern around the central rotation axis Y so as to emit a laser beam r in the direction of the core 9, for measuring the dimensional variations of the core (thus detecting the thickness of the layers 1′, 1″ being formed) and the uniformity and/or compactness of the layers.

In this manner it is advantageously possible to verify the correct dosage of all the components of the dosage form during the production process.

According to an optional and advantageous characteristic, the apparatus 10, 100, 1000 comprises a radiative drying system (not shown) to facilitate the drying of the layers 1′, 1″ of pharmaceutical compounds deposited on the core 9.

In greater detail, radiative drying systems are systems that by emitting radiation and/or heat in the direction of the core 9 facilitate the drying of the layers 1′, 1″ deposited thereon. In practice, radiative drying systems comprise one or more devices for emitting radiation and/or heat, such as for example UV lamps, electrical resistance heaters, laser emitters, etcetera, configured to irradiate the core 9.

According to another optional and advantageous characteristic, the sterile chamber 20 can be replaced, i.e, can be removed and interchanged with other sterile chambers.

In practice, in the preferred embodiments, the protective shell 21 can be removed together with the core supporting assembly 31 so that it can be replaced with another shell 21 and with another core supporting assembly 30. In other embodiments, it is possible to replace, independently, only the shell 21 or only the core supporting assembly 30. In this manner, in case of cross-contamination, due for example to the accidental deposition of a pharmaceutical compound, it is possible to replace the protective shell 21 and the core supporting assembly 30 with other sterile ones and it is therefore possible to resume production rapidly and economically.

FIGS. 11 to 18 show some possible non-limiting embodiments of cores suitable for being used in an apparatus 10, 100, 1000 according to the disclosure for the provision of an oral dosage form. In order to facilitate comprehension, in the figures the cores 9A, 9B, 9C, 9D are shown with two layers 1′, 1″ of pharmaceutical products applied, which however are not part of the core 9A, 9B, 9C, 9D.

All these cores 9A, 9B, 9C, 9D are provided with a groove 91 adapted to be partially filled by the layers 1′, 1″ of pharmaceutical compounds.

FIGS. 11 and 12 show a core 9A with circular plan shape, composed substantially of two spherical domes, with identical and mutually facing end faces, spaced by a cylindrical central portion that is smaller in diameter than the end faces of the two spherical domes. A circumferential groove 91 is thus formed between the two domes and its depth is equal to the difference between the radius of the end faces of the spherical domes and the radius of the central cylindrical portion.

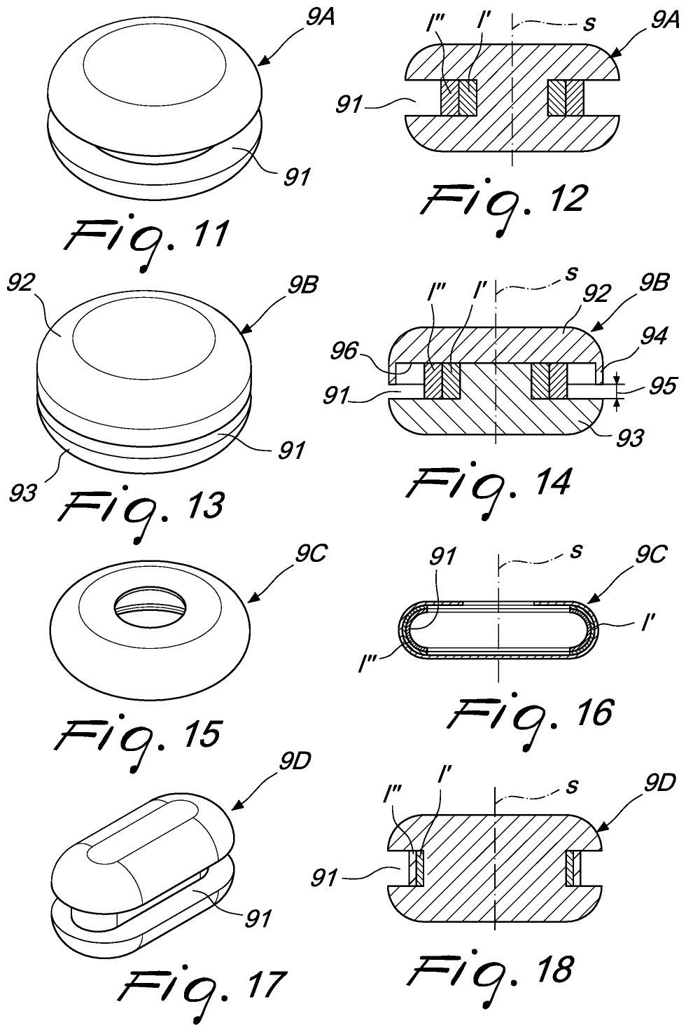

The core 9B shown in FIGS. 13 and 14a also has a circular plan shape and also is composed substantially of two spherical domes (an upper dome 92 and a lower dome 93), with equal and mutually facing end faces, spaced by a cylindrical central portion having a smaller diameter than the end faces of the two spherical domes, with the particularity that on the end face of the upper dome 92 there is an annular recess 96 adjacent to the cylindrical central portion. Also in this core 9B, between the two domes 92, 93 a circumferential groove 91 is defined, the depth of which is equal to the difference between the radius of the end faces of the spherical domes 92, 93 and the radius of the cylindrical central portion. As can be seen in FIG. 14, the groove 91 is here covered partially outward by an annular shoulder 94 that protrudes from the perimeter of the end face of the upper dome 92 toward the lower dome 93.

In this core 9B, the upper dome 92 is provided as a separate part and is movable closer to the lower dome 93 up to a closed condition in which the annular shoulder 94 reduces, by closing at least partially, the opening 95 of the groove 91 (i.e., the passage opening between the groove 91 and the outside). The approach of the two domes 92, 93 can occur following a mechanical action (pressure or screwing). In this manner, in the closed condition, the layers 1′, 1″ deposed inside the groove 91 are protected against mechanical interference with the outside, although access to liquids, such as for example gastric juices, is not prevented.

FIGS. 15 and 16 show a core 9C shaped like an internally hollow toroid and open in the inner portion, so that the cavity is accessible from the central hole. In practice, in this core 9C the groove 91 is constituted by the internal cavity of the toroid.

FIGS. 17 and 18 show a core 9D which is substantially identical to the first core 9A described, with the only difference that the plan shape is not circular but elongated.

It should be noted that each one of the first three cores 9A, 9B, 9C shown has advantageously a symmetrical shape with respect to a central axis S and is provided with a perimetric groove 91, which is in turn symmetrical with respect to said central axis S. In this manner, by making the central axis S of the core coincide with the central rotation axis Y of the apparatus 10, 100, 1000, it is possible to ensure in a simple and practical manner an even deposition of the layers 1′, 1″ inside the groove during rotation.

As mentioned, the cores 9A, 9B, 9C, 9D are made conveniently of inert edible material and are preferably constituted by a rigid part.

In the embodiments shown in FIGS. 11-12, 15-16 and 17-18, the part that constitutes the core is constituted by a single monolithic part.

In the embodiment shown in FIGS. 13-14, the part comprises two mechanical assembled portions, constituted by the upper dome 92 and the lower dome 93.

Even more preferably, the part that constitutes the cores 9A, 9B, 9C, 9D is obtained by injection molding.

In any case, the apparatus 10, 100, 1000 according to the disclosure can be configured to use even other types of core 9, such as for example the one shown in FIGS. 19 and 20 during use in the advanced embodiment 1000 of the apparatus already described; it should be noted that this core 9 is provided with two perimetric grooves 91 and, moreover, with an auxiliary groove 99 also adapted to be at least partially filled with a pharmaceutical compound emitted by one or more dispensing devices 50.

The operation of the apparatus 10, 100, 1000 is clear and evident from what has been described.

It is noted here that the work area is gathered in a single work station, thus allowing to reduce the dimensions of the apparatus.

The reduced dimensions and its simplicity make the apparatus 10, 100, 1000 particularly suitable for use in the hospital sector.

Moreover, the apparatus 10, 100, 1000 does not require any reconfiguration of the components when it is necessary to vary the order of insertion of the various pharmaceutical compounds (it is in fact sufficient to vary the dispensing order by means of the dispensing devices 50).

The method for the automated production of customizable dosage forms that is the subject matter of the present disclosure can be provided by the apparatus 10, 100, 1000 and is described hereinafter.

First of all it is necessary to predefine a number of layers 1′, 1″ and, for each layer 1′, 1″, to predefine a thickness and a pharmaceutical compound and also choose a suitable core 9, such as for example one of the cores 9A, 9B, 9C, 9D described previously.

The number, the thickness and the composition of the layers 1′, 1″, as well as the shape of the core 9, will determine the pharmacological characteristics of the dosage form and therefore are defined in relation to the needs of the patient, in accordance with medical practice.

Conveniently, the chosen core 9 is preferably provided with at least one perimetric groove 91 which is deeper than the sum of the thicknesses of the predefined layers 1′, 1″.

The core 9 is thus retained (i.e., held in position) inside a sterile chamber 20, preferably centered on a central rotation axis Y; for example, the core 9 is positioned in the chamber of the apparatus 10, 100, and is retained by the core supporting assembly 30 with the central axis S coinciding with the central rotation axis Y of the apparatus 10, 100.

Subsequently, the core 9 is rotated about the central rotation axis Y, for example by being rotationally actuated by the core supporting assembly 30, which in turn is rotationally actuated by the motor assembly 40; as an alternative, instead of the core 9, one or more dispensing devices 50 are rotationally actuated, again around the central rotation axis Y.

The method, according to the disclosure, entails that during rotation one or more jets g of a pharmaceutical compound are emitted by at least one dispensing device 50 in the direction of at least one perimetric portion of the core 9, and preferably in the direction of the groove 91, so as to deposit on said portion, i.e., inside said groove 91, a layer 1′ of said pharmaceutical compound having the predefined thickness.

In practice, by providing the method in one of the apparatuses 10, 100 here described, while the core supporting assembly 30 rotationally actuates the core 9, at least one dispensing device 50 dispenses radially (in liquid or power form) the pharmaceutical compound, depositing a layer 1′ thereof inside the groove 91 of the core.

Once a first layer 1′ has been deposited, the dispensing process of the pharmaceutical compound is optionally repeated by dispensing another compound from at least one other dispensing device 50, thus depositing a second layer 1″ and then optionally a third one and so forth.

In other words, the preceding step is performed a number of times equal to the predefined number of layers, each time emitting a jet g of the predefined pharmaceutical compound for the corresponding layer, so as to deposit sequentially all the predefined layers 1′, 1″ inside the groove 91, each layer being composed of the predefined pharmaceutical compound and having the predefined thickness.

Obviously, it is possible to limit oneself to the application of a single layer.

Optionally, after the deposition of each layer 1′, 1″, the thickness and/or one or more physical characteristics of the layer 1′, 1″ just deposited are measured by means of one or more optical measurement devices 60, in order to verify their correct deposition (i.e., verify that the quantity of deposited pharmaceutical compound is the correct one and/or that the layer has the right compactness).

The final product obtained is therefore constituted by a dosage form comprising a core 9 and one or more layers 1′, 1″ of pharmaceutical compounds.

Some examples of pharmaceutical forms that can be obtained with the present method are in practice visible in FIGS. 11 to 18, in which the cores are shown with two layers 1′, 1″ applied.

As is evident, said pharmaceutical forms are particularly suitable for oral administration, since in practice they have a pill-like shape.

It should be noted that since the groove 91 inside which the layers 1′, 1″ are deposited is deeper than the sum of the thicknesses of said layers, the layers 1′, 1″ are protected against abrasions and mechanical impacts without the presence of any auxiliary coating.

However, it is possible to use a core having a groove 91 the depth of which is lower than the sum of the thicknesses of the deposited layers 1″, 1″ and therefore, at the end of the deposition process, a portion of the layers 1′, 1″ of pharmaceutical compounds will protrude outside the groove 91. In this alternative embodiment of the method, after the deposition of the layers of pharmaceutical compounds 1′, 1″, a final chemical protective layer which has the function of providing mechanical protection to the underlying layers is deposited by means of one of the dispensing devices 50.

If a core such as the one shown in FIGS. 13-14 is used, the method entails that, after the layers 1′, 1″ have been deposited, one proceeds to move (by means of a mechanical pressing or screwing action) the upper dome 92 of the core 91 closer to the lower dome 93 up to said closed condition, so as to protect the layers 1′, 1″ deposited within the groove 91 from mechanical interference with the outside.

It is also noted that the release kinetics is closely controlled by the geometry of the core 9 and therefore it is possible to use as a pharmaceutical compound a single liquid base in which the appropriate active ingredients are dissolved.

Moreover, the release kinetics is not affected by the need to add an external protective layer.

Finally, it should be stressed that with the apparatus and the method according to the present disclosure it is possible to develop a potentially infinite number of releases of potentially infinite products, in a controlled manner.

In practice it has been found that the apparatus and the method for the automated production of customizable dosage forms, according to the present disclosure, fully achieve the intended aim and objects, since they allow to produce oral dosage forms in the hospital sector in an automated and at the same time economical, fast and reliable manner.

Another advantage of the apparatus and of the method, according to the disclosure, includes allowing to provide oral dosage forms that are completely customizable both in terms of active ingredients and in terms of release rate.

A further advantage of the apparatus and of the method, according to the disclosure, relates to allowing control of the dosage and compactness of each individual dosage form during production.

Another advantage of the apparatus and of the method, according to the disclosure, involves reducing the risk of cross-contamination with respect to the background art.

A further advantage of the apparatus and of the method, according to the disclosure, includes avoiding the application of a protective coating without compromising the reliability of the dosage form.

A further advantage of the apparatus, according to the disclosure, relates to being less bulky than the background art.

Another advantage of the apparatus, according to the disclosure, is being more flexible and easier to reconfigure than the background art.

A further advantage of the apparatus, according to the disclosure, is that if cross-contamination has occurred, it can be restarted in a faster and more economical manner with respect to the background art.

Another advantage of the apparatus and of the method, according to the disclosure, is that they are easy to provide and economically competitive if compared with the background art.

The apparatus and the method for the automated production of customizable dosage forms thus conceived are susceptible of numerous modifications and variations, all of which are within the scope of the appended claims.

All the details may furthermore be replaced with other technically equivalent elements.

The disclosures in Italian Patent Application No. 102018000004265 from which this application claims priority are incorporated herein by reference.

1-18. (canceled)

19. An apparatus for the automated production of customizable dosage forms, comprising a sterile chamber inside which a dosage form is formed, the apparatus comprising:
a core supporting assembly for retaining a core inside said sterile chamber;
one or more dispensing devices, each of which is configured to emit, in a controlled manner, in a direction of the core retained by said core supporting assembly, a jet of a pharmaceutical compound; and
a motor assembly, adapted to transmit a rotation about a central rotation axis to said core supporting assembly and with it to said core or to said at least one dispensing device;
said motor assembly and said one or more dispensing devices being configured so that during said rotation said one or more dispensing devices deposit one or more layers of a predefined thickness of said one or more pharmaceutical compounds on at least one perimetric portion of said core.

20. The apparatus according to claim 19, wherein said one or more dispensing devices are arranged in a radial pattern around said central rotation axis.

21. The apparatus according to claim 19, further comprising a plurality of said dispensing devices arranged perimetrically on a rotating base, which can rotate about a peripheral axis, so that by rotating said base each one of said dispensing devices is configured to be oriented selectively toward said central rotation axis.

22. The apparatus according to claim 19, wherein said sterile chamber comprises a protective shell, which is interposed between said core supporting assembly and said dispensing devices; said protective shell being provided with one or more slots for the passage of the jets of pharmaceutical compounds dispensed by said dispensing devices toward said core.

23. The apparatus according to claim 19, further comprising one or more optical measurement devices for measuring a thickness of said one or more layers of pharmaceutical compounds deposited on said core and/or to measure one or more physical characteristics of said layers.

24. The apparatus according to claim 19, wherein said sterile chamber comprises a temperature, humidity and pressure control system in order to maintain a temperature, humidity and pressure at predetermined values at predetermined values within said sterile chamber and/or a device for creating a laminar flow of sterile air within said sterile chamber).

25. The apparatus according to claim 19, further comprising a system for drying by radiation to facilitate the drying of said one or more layers of pharmaceutical compounds deposited on said core.

26. The apparatus according to claim 19, wherein said sterile chamber is removable and is interchangeable with other sterile chambers.

27. A core for the production of a dosage form in an apparatus according to claim 19, wherein it is constituted by a piece of inert edible material which has a symmetrical shape with respect to a central axis and is provided with at least one perimetric groove, which is in turn symmetrical with respect to said central axis and is adapted to be filled partially by one or more layers of pharmaceutical compounds.

28. The core according to claim 27, wherein said groove is formed between a lower dome and an upper dome which is provided with an annular shoulder which protrudes toward said lower dome; said upper dome being movable closer to said lower dome up to a closed condition in which said annular shoulder reduces, closing at least partially, the opening of the groove.

29. A method for the automated production of customizable dosage forms, the method including the preliminary step of predefining a number of layers and for each layer predefining a thickness and a pharmaceutical compound and further including the steps of:
a) providing a core of inert edible material;
b) retaining said core within a sterile chamber;
c) rotating said core, or one or more dispensing devices, about a central rotation axis;
d) during rotation, emitting, from at least one dispensing device, one or more jets of a pharmaceutical compound in the direction of at least one perimetric portion of the core so as to deposit thereon a layer of said pharmaceutical compound of the predefined thickness; and
e) performing the preceding step a number of times equal to the predefined number of layers, each time emitting a jet of the predefined pharmaceutical compound for the corresponding layer, so as to deposit sequentially all the predefined layers, each of which is composed of the predefined pharmaceutical compound and has the predefined thickness.

30. The method according to claim 29, wherein in step a) a core is provided which has at least one perimetric groove which is deeper than the sum of the thicknesses of the predefined layers and in step d) and step e) said one or more jets of pharmaceutical compound are emitted in the direction of said at least one groove of the core, so as to deposit inside said at least one groove, sequentially, all the predefined layers, each of which is composed of the predefined pharmaceutical compound and has the predefined thickness.

31. The method according to claim 29, wherein in step a) a core is provided which has at least one perimetric groove the depth of which is less than the sum of the thicknesses of the predefined layers and in that it comprises the additional step of:
f) depositing, after the deposition of the layers of predefined pharmaceutical compounds and by means of one of the dispensing devices, a final chemical protective layer which has the function of providing mechanical protection to said underlying layers.

32. The method according to claim 30, wherein in step a) a core is provided constituted by a piece of inert edible material which has a symmetrical shape with respect to a central axis and is provided with at least one perimetric groove, which is in turn symmetrical with respect to said central axis and is adapted to be filled partially by one or more layers of pharmaceutical compounds, wherein said groove is formed between a lower dome and an upper dome which is provided with an annular shoulder which protrudes toward said lower dome; said upper dome being movable closer to said lower dome up to a closed condition in which said annular shoulder reduces, closing at least partially, the opening of the groove, and it further comprises a final step of:
moving said upper dome of the core closer to said lower dome up to said closed condition, so as to protect the layers deposited within the groove from mechanical interference with the outside.

33. The method according to claim 30, wherein in step a) a core is provided constituted by a piece of inert edible material which has a symmetrical shape with respect to a central axis and is provided with at least one perimetric groove, which is in turn symmetrical with respect to said central axis and is adapted to be filled partially by one or more layers of pharmaceutical compounds, wherein said groove is formed between a lower dome and an upper dome which is provided with an annular shoulder which protrudes toward said lower dome; said upper dome being movable closer to said lower dome up to a closed condition in which said annular shoulder reduces, closing at least partially, the opening of the groove.

34. The method according to claim 29, wherein in step d) the thickness and/or one or more physical characteristics of the deposited layer are measured, by means of one or more optical measurement devices, in order to check the correct deposition of the layer.

35. The method according to claim 29, performed with an apparatus comprising:
a core supporting assembly for retaining a core inside said sterile chamber;
one or more dispensing devices, each of which is configured to emit, in a controlled manner, in a direction of the core retained by said core supporting assembly, a jet of a pharmaceutical compound; and
a motor assembly, adapted to transmit a rotation about a central rotation axis to said core supporting assembly and with it to said core or to said at least one dispensing device;
said motor assembly and said one or more dispensing devices being configured so that during said rotation said one or more dispensing devices deposit one or more layers of a predefined thickness of said one or more pharmaceutical compounds on at least one perimetric portion of said core.

36. A dosage form provided with a method according to claim 29.
